(19) United States
(12) Patent Application Publication
(10) Pub. No.: US 2026/0340004 A1
(43) Pub. Date: Oct. 29, 2026

(54) CROSS ENCODERS FOR INFORMATION RETRIEVAL

(71) Applicant: International Business Machines Corporation, Armonk, NY (US)

(72) Inventors: Kavitha SRINIVAS, Port Chester, NY (US); Haritha ANANTHAKRISHNAN, Amherst, MA (US); Julian Timothy DOLBY, Bronx, NY (US); Harsha KOKEL, Milpitas, CA (US); Horst Cornelius SAMULOWITZ, Armonk, NY (US)

(21) Appl. No.: 19/188,601

(22) Filed: Apr. 24, 2025

(51) Int. Cl. G06F 16/334; G06F 16/31

(52) U.S. Cl. CPC G06F 16/334; G06F 16/31

(57) ABSTRACT

In some implementations, a wireless device may receive a sentence to be embedded for search. The wireless device may pair the sentence with itself to create a paired sentence input for a cross-encoder. The wireless device may provide the paired sentence input to the cross-encoder to generate a representation of the sentence. The wireless device may extract an abstract representation of the sentence from a lower layer of the cross-encoder, where the abstract representation of the sentence is associated with search. The wireless device may index the abstract representation of the sentence in an index for search. The wireless device may search the index for sentences similar to the abstract representation of the sentence.

### BACKGROUND

This disclosure relates to searching information, and more specifically, to using cross-encoders for information retrieval.

### SUMMARY

Some aspects described herein relate to a method. The method may include receiving a sentence to be embedded for search. The method may include pairing the sentence with itself to create a paired sentence input for a cross-encoder. The method may include providing the paired sentence input to the cross-encoder. The method may include extracting an abstract representation of the sentence from a lower layer of the cross-encoder, wherein the abstract representation of the sentence is associated with search. The method may include indexing the abstract representation of the sentence in an index for search. The method may include searching the index for sentences similar to the abstract representation of the sentence.

Some aspects described herein relate to a computer system. The computer system may include a processor set, one or more computer-readable storage media, and program instructions stored on the one or more computer-readable storage media to cause the processor set to perform operations. The operations may include receiving a query input. The operations may include providing the query input paired with itself to a first cross-encoder. The operations may include receiving a first embedding from a layer of the first cross-encoder that is close to the query input. The operations may include storing the first embedding in a vector index. The operations may include receiving a search request including a target query input. The operations may include providing the target query input paired with itself to a second cross-encoder. The operations may include receiving a second embedding for the target query input from the layer of the second cross-encoder. The operations may include searching the vector index for a set of embeddings that are closest to the second embedding for the target query input. The operations may include returning a result based on the set of embeddings.

Some aspects described herein relate to a computer program product. The computer program product may include one or more computer-readable storage media and program instructions stored on the one or more computer-readable storage media to perform operations. The operations may include embedding a sentence in a cross-encoder by pairing the sentence with itself. The operations may include extracting an abstract representation of the sentence from an earlier layer of the cross-encoder. The operations may include creating an index of sentence embeddings for use in searching for sentences similar to a given query sentence. The operations may include embedding the query sentence using the cross-encoder. The operations may include searching the index for similar sentence embeddings. The operations may include outputting the similar sentence embeddings.

### BRIEF DESCRIPTION OF THE DRAWINGS

FIG. 1 is a diagram of an example computing environment for search using cross-encoders, as described herein.

FIG. 2 is a diagram illustrating an example of a dual encoder and a cross-encoder.

FIG. 3 is a diagram illustrating an example of a cross-encoder using a sentence paired with itself.

FIG. 4 is a diagram of an example implementation for using a cross-encoder for search.

FIGS. 5A and 5B are diagrams of an example implementation associated with using a cross-encoder for search.

FIG. 6 is a flowchart of an example process associated with using a cross-encoder for search.

FIG. 7 is a flowchart of an example process associated with using a cross-encoder for search.

FIG. 8 is a flowchart of an example process associated with using a cross-encoder for search.

### DETAILED DESCRIPTION

The following detailed description of example implementations refers to the accompanying drawings. The same reference numbers in different drawings may identify the same or similar elements.

According to an aspect, there is provided a computer-implemented method that includes receiving a sentence to be embedded for search. The method may include pairing the sentence with itself to create a paired sentence input for a cross-encoder. The method may include providing the paired sentence input to the cross-encoder. The method may include extracting an abstract representation of the sentence from a lower layer of the cross-encoder, wherein the abstract representation of the sentence is associated with search. The method may include indexing the abstract representation of the sentence in an index for search. The method may include searching the index for sentences similar to the abstract representation of the sentence.

By using a sentence paired with itself as input for a cross-encoder to generate an abstract representation of the sentence from a lower layer of the cross-encoder, the computer system can enable more accurate and relevant search results while conserving processing resources, memory resources, network resources, and/or the like. By indexing the abstract representation of the sentence, the computer can quickly and efficiently search for similar sentences, reducing the processing resources required for search operations. Additionally, the computer system allows for the training of a dual encoder using the abstract representation of the sentence from the cross-encoder, with a simpler training regimen, thereby reducing the processing resources associated with training and optimizing the model.

In one or more embodiments, the lower layer of the cross-encoder comprises one or more of an embedding layer, a zeroth layer, or a first layer of the cross-encoder. By using fewer layers, processing resources are conserved.

In one or more embodiments, the abstract representation of the sentence is extracted from the lower layer of the cross-encoder by pooling hidden states from the lower layer. Pooling hidden states from the lower layer of the cross-encoder can help capture local semantic features, such as word meaning and syntactic structure, that are relevant to the search task. Pooling can help reduce the noise and variability in the hidden states, resulting in a more stable and robust representation of the sentence. By pooling the hidden states, the dimensionality of the representation is reduced, making it more compact and efficient to store and process.

In one or more embodiments, the cross-encoder is a pre-trained cross-encoder trained on sentence pairs to detect relatedness between sentences. In some implementations, the indexing of the abstract representation comprises storing the abstract representation in a k-nearest-neighbor index for search. This reduces the latency of the search.

In one or more embodiments, the searching of the index comprises searching the index using a query sentence to find similar sentences to the query sentence. In some implementations, the sentence comprises a column of a table. In one or more embodiments, the cross-encoder is a cross-encoder for tables trained to detect relatedness between columns of tables. This reduces the latency of the search.

In one or more embodiments, the method includes training a dual encoder using the abstract representation of the sentence from the cross-encoder and training the dual encoder using a simpler training regimen than training a dual encoder from an initial state. The simpler training regimen includes a number of parameters that is below a parameter number threshold or a number of layers below a layer threshold. This reduces the latency of the search and conserves processing resources.

In one or more embodiments, the method includes refining results of the search by reranking the results with the cross-encoder.

Some aspects described herein relate to a computer system. The computer system may include a processor set, one or more computer-readable storage media, and program instructions stored on the one or more computer-readable storage media to cause the processor set to perform operations. The operations may include receiving a query input. The operations may include providing the query input paired with itself to a first cross-encoder. The operations may include receiving a first embedding from a layer of the first cross-encoder that is close to the query input. The operations may include storing the first embedding in a vector index. The operations may include receiving a search request including a target query input. The operations may include providing the target query input paired with itself to a second cross-encoder. The operations may include receiving a second embedding for the target query input from the layer of the second cross-encoder. The operations may include searching the vector index for a set of embeddings that are closest to the second embedding for the target query input. The operations may include returning a result based on the set of embeddings.

By using a query input paired with itself as input for a cross-encoder to generate an abstract representation of the query input from a lower layer of the cross-encoder, the computer system can enable more accurate and relevant search results while conserving processing resources, memory resources, network resources, and/or the like. By indexing the abstract representation of the query input, the computer can quickly and efficiently search for similar sentences, reducing the processing resources required for search operations. Additionally, the computer system allows for the training of a dual encoder using the abstract representation of the sentence from the cross-encoder, with a simpler training regimen, thereby reducing the processing resources associated with training and optimizing the model.

In one or more embodiments, the first cross-encoder and the second cross-encoder are the same cross-encoder. In one or more embodiments, the layer of the first cross-encoder close to the query input is one of a first layer or a second layer of the first cross-encoder. Using only the first or second layers reduces the latency of the search and conserves processing resources.

In one or more embodiments, the method includes pretraining the second cross-encoder on a paired-input training dataset before performing the providing and returning operations. Pretraining reduces the latency of the search.

In one or more embodiments, the query input comprises one of a table column or a sentence, and the result comprises an indication of one of a related table column or a related sentence based on the set of embeddings.

Some aspects described herein relate to a computer program product. The computer program product may include one or more computer-readable storage media and program instructions stored on the one or more computer-readable storage media to perform operations. The operations may include embedding a sentence in a cross-encoder by pairing the sentence with itself. The operations may include extracting an abstract representation of the sentence from an earlier layer of the cross-encoder. The operations may include creating an index of sentence embeddings for use in searching for sentences similar to a given query sentence. The operations may include embedding the query sentence using the cross-encoder. The operations may include searching the index for similar sentence embeddings. The operations may include outputting the similar sentence embeddings.

By using a sentence paired with itself as input for a cross-encoder to generate an abstract representation of the sentence from a lower layer of the cross-encoder, the computer system can enable more accurate and relevant search results while conserving processing resources, memory resources, network resources, and/or the like. By indexing the abstract representation of the sentence, the computer can quickly and efficiently search for similar sentences, reducing the processing resources required for search operations. Additionally, the computer system allows for the training of a dual encoder using the abstract representation of the sentence from the cross-encoder, with a simpler training regimen, thereby reducing the processing resources associated with training and optimizing the model.

In one or more embodiments, the method includes embedding columns of a table using the cross-encoder, extracting an abstract representation of the columns from an earlier layer of the cross-encoder, creating an index of column embeddings for use in searching for columns similar to a given query column, embedding the query column using the cross-encoder, and searching the index for similar column embeddings. By extracting from an earlier layer, the latency of the search is reduced and processing resources are conserved.

In one or more embodiments, the extracting of the abstract representation comprises extracting the abstract representation by pooling hidden states from the earlier layer or a lower layer of the cross-encoder. Pooling hidden states from the lower layer of the cross-encoder can help capture local semantic features, such as word meaning and syntactic structure, that are relevant to the search task. Pooling can help reduce the noise and variability in the hidden states, resulting in a more stable and robust representation of the sentence. By pooling the hidden states, the dimensionality of the representation is reduced, making it more compact and efficient to store and process. In one or more embodiments, the hidden states are pooled using a sum pooling operation or a maximum pooling operation.

Information retrieval systems can involve comparisons between user queries and vast numbers of documents or sentences, with the goal of retrieving the most relevant items. Queries may include sentences that are be embedded for search. This may involve using natural language processing (NLP) to represent the sentences as dense vectors in a high-dimensional space, allowing for efficient and effective search and retrieval of similar sentences. Traditional approaches to sentence embedding for information retrieval may involve dual encoder models, where two separate encoders process the query and candidate sentences to generate the vector representations. These vector representations are then compared to determine similarity. However, a single high-quality sentence embedding can capture complex semantic meaning, posing significant challenges in finding optimal representations.

One issue with sentence embedding is that the encoders require large amounts of training data to learn high-quality sentence representations and are often computationally expensive. Dual encoders are typically more restrictive and less accurate than cross-encoder models that directly compare pairs of sentences, as dual encoders must learn abstract representations of individual sentences in a vacuum. Retrieval systems typically require efficiency over large sets of data, and traditional dual encoder methods can be slower and less accurate in various real-world applications, such as natural language question answering, text search, and other information retrieval tasks.

Some implementations described herein include a computer system that employs a pre-trained cross-encoder to generate abstract representations of sentences. For example, a sentence is paired with itself as input to the cross-encoder, and an abstract representation is extracted from a lower layer of the cross-encoder for indexing and search. In this way, the computer system provides a more efficient and effective approach to sentence embedding, leveraging the strengths of cross-encoder models while avoiding the complexity and computational expense of traditional dual encoder methods. The computer system conserves computing resources by reducing the number of parameters required for training, minimizes memory usage by eliminating the need for large training datasets, and enables faster inference times by streamlining the processing pipeline. Furthermore, the computer system may conserve network resources by reducing the amount of data required for transmission during training and deployment.

Additionally, the computer system allows for the training of a dual encoder using the abstract representation of the sentence from the cross-encoder, with a simpler training regimen, thereby reducing the computational requirements associated with training and optimizing the model. In this way, the computer system conserves processing resources, memory resources, network resources, and/or the like, making the cross-encoder well-suited for various natural language processing applications, including question answering, text search, and information retrieval tasks.

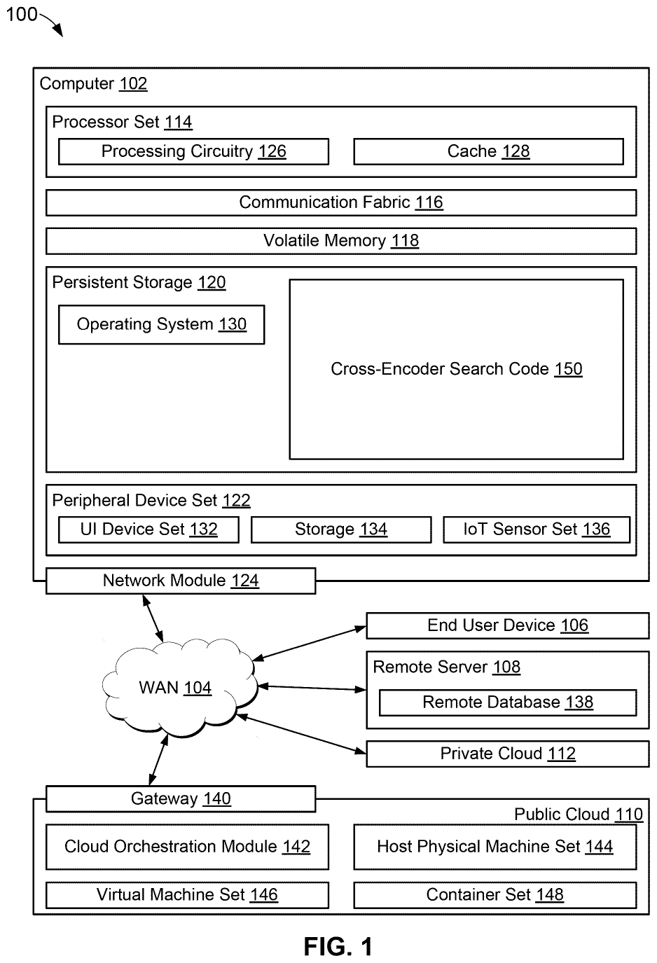

FIG. 1 is a diagram of an example computing environment 100 for search using cross-encoders, as described herein.

Computing environment 100 contains an example of an environment for the execution of at least some of the computer code involved in performing the inventive methods, such as cross-encoder search code 150. In addition to cross-encoder search code 150, computing environment 100 includes, for example, computer 102, wide area network (WAN) 104, end user device (EUD) 106, remote server 108, public cloud 110, and private cloud 112. In this embodiment, computer 102 includes processor set 114 (including processing circuitry 126 and cache 128), communication fabric 116, volatile memory 118, persistent storage 120 (including operating system 130 and cross-encoder search code 150, as identified above), peripheral device set 122 (including user interface (UI) device set 132, storage 134, and Internet of Things (IoT) sensor set 136), and network module 124. Remote server 108 includes remote database 138. Public cloud 110 includes gateway 140, cloud orchestration module 142, host physical machine set 144, virtual machine set 146, and container set 148.

Computer 102 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network, or querying a database, such as remote database 138. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 102, to keep the presentation as simple as possible. Computer 102 may be located in a cloud, even though it is not shown in a cloud in FIG. 1. On the other hand, computer 102 is not required to be in a cloud except to any extent as may be affirmatively indicated.

Processor set 114 includes one, or more, computer processors of any type now known or to be developed in the future. Processing circuitry 126 may be distributed over multiple packages (for example, multiple, coordinated integrated circuit chips). Processing circuitry 126 may implement multiple processor threads and/or multiple processor cores. Cache 128 is memory that is located in the processor chip package(s) and is typically used for data or code that should be available for rapid access by the threads or cores running on processor set 114. Cache memories are typically organized into multiple levels depending upon relative proximity to the processing circuitry. Alternatively, some, or all, of the cache for the processor set may be located “off chip.” In some computing environments, processor set 114 may be designed for working with qubits and performing quantum computing.

Computer-readable program instructions are typically loaded onto computer 102 to cause a series of operational steps to be performed by processor set 114 of computer 102 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 128 and the other storage media discussed below. The program instructions, and associated data, are accessed by processor set 114 to control and direct performance of the inventive methods. In computing environment 100, at least some of the instructions for performing the inventive methods may be stored in cross-encoder search code 150 in persistent storage 120.

Communication fabric 116 is the signal conduction path that allows the various components of computer 102 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

Volatile memory 118 is any type of volatile memory now known or to be developed in the future. Examples include dynamic type random access memory (RAM) or static type RAM. Typically, volatile memory 118 is characterized by random access, but this is not required unless affirmatively indicated. In computer 102, the volatile memory 118 is located in a single package and is internal to computer 102, but, alternatively or additionally, the volatile memory may be distributed over multiple packages and/or located externally with respect to computer 102.

Persistent storage 120 is any form of non-volatile storage for computers that is now known or to be developed in the future. The non-volatility of this storage means that the stored data is maintained regardless of whether power is being supplied to computer 102 and/or directly to persistent storage 120. Persistent storage 120 may be a read only memory (ROM) , but typically at least a portion of the persistent storage allows writing of data, deletion of data, and re-writing of data. Some familiar forms of persistent storage include magnetic disks and solid-state storage devices. Operating system 130 may take any of several forms, such as various known proprietary operating systems or open source Portable Operating System Interface-type operating systems that employ a kernel.

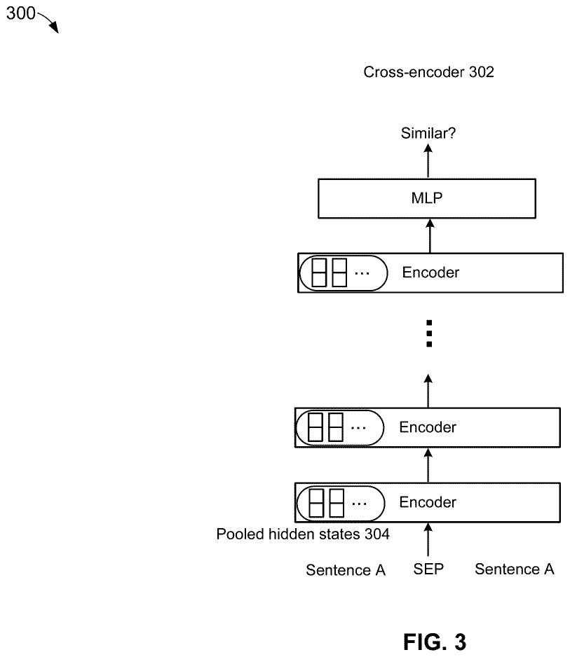

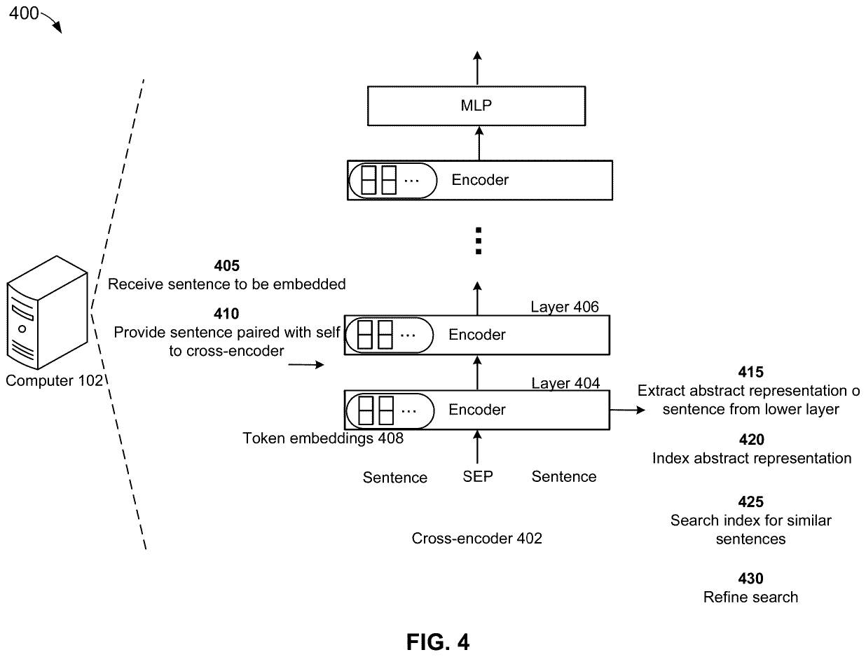

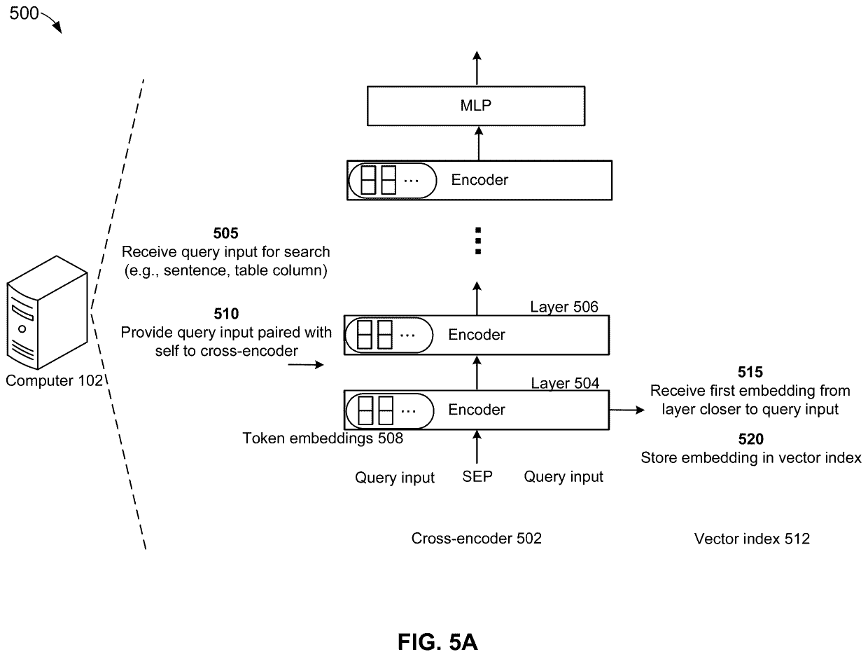

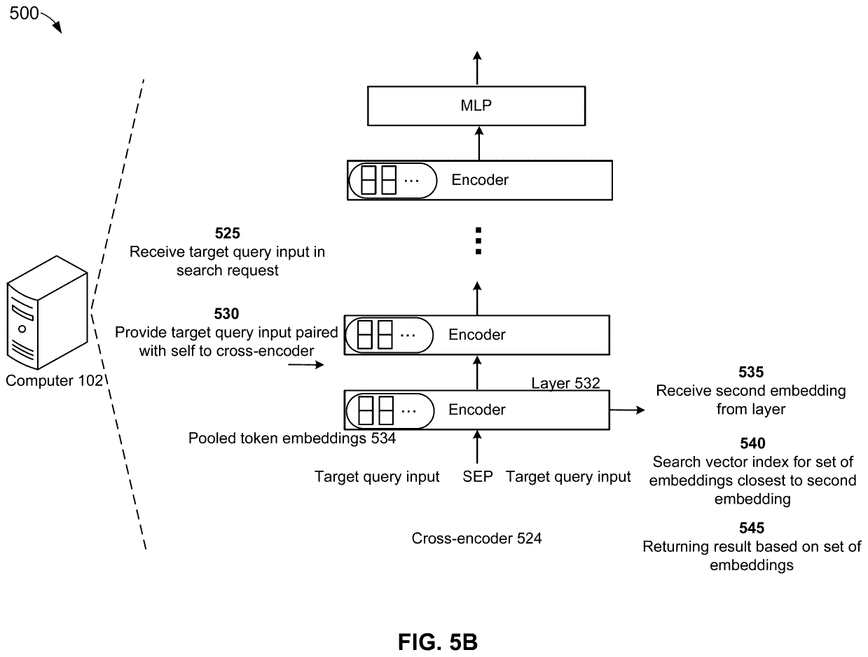

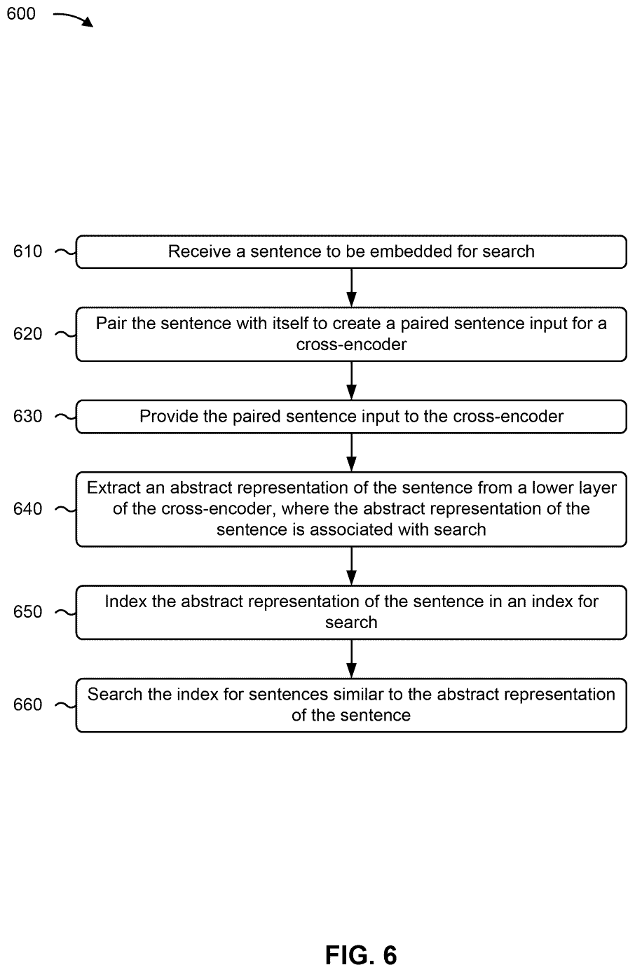

The code included in the cross-encoder search code 150 typically includes at least some of the computer code involved in performing one or more operations described herein, such as the operations of implementation 300 in FIG. 3, implementation 400 in FIG. 4, implementation 500 in FIGS. 5A-5B, and the processes described in FIGS. 6-8.

Peripheral device set 122 includes the set of peripheral devices of computer 102. Data communication connections between the peripheral devices and the other components of computer 102 may be implemented in various ways, such as Bluetooth® connections, Near-Field Communication (NFC) connections, connections made by cables (such as universal serial bus (USB) type cables), insertion-type connections (for example, secure digital (SD) card), connections made through local area communication networks and/or connections made through wide area networks such as the internet. In various embodiments, UI device set 132 may include components such as a display screen, speaker, microphone, wearable devices (such as goggles and smart watches), keyboard, mouse, printer, touchpad, game controllers, and/or haptic devices. Storage 134 is external storage, such as an external hard drive, or insertable storage, such as an SD card. Storage 134 may be persistent and/or volatile. In some embodiments, storage 134 may take the form of a quantum computing storage device for storing data in the form of qubits. In embodiments where computer 102 is required to have a large amount of storage (for example, where computer 102 locally stores and manages a large database), this storage may be provided by peripheral storage devices designed for storing very large amounts of data, such as a storage area network (SAN) that is shared by multiple, geographically distributed computers. IoT sensor set 136 is made up of sensors that can be used in Internet of Things applications. For example, one sensor may be a thermometer and another sensor may be a motion detector.

Network module 124 is the collection of computer software, hardware, and firmware that allows computer 102 to communicate with other computers through WAN 104. Network module 124 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 124 are performed on the same physical hardware device. In other embodiments (for example, embodiments that utilize software-defined networking (SDN)), the control functions and the forwarding functions of network module 124 are performed on physically separate devices, such that the control functions manage several different network hardware devices. Computer-readable program instructions for performing the inventive methods can typically be downloaded to computer 102 from an external computer or external storage device through a network adapter card or network interface included in network module 124.

WAN 104 is any wide area network (for example, the internet) capable of communicating computer data over non-local distances by any technology for communicating computer data, now known or to be developed in the future. In some embodiments, the WAN 104 may be replaced and/or supplemented by local area networks (LANs) designed to communicate data between devices located in a local area, such as a Wi-Fi network. The WAN and/or LA Ns typically include computer hardware such as copper transmission cables, optical transmission fibers, wireless transmission, routers, firewalls, switches, gateway computers and/or edge servers.

End user device (EUD) 106 is any computer system that is used and controlled by an end user (for example, a customer of an enterprise that operates computer 102), and may take any of the forms discussed above in connection with computer 102. EUD 106 typically receives helpful and useful data from the operations of computer 102. For example, in a hypothetical case where computer 102 is designed to provide a recommendation to an end user, this recommendation would typically be communicated from network module 124 of computer 102 through WAN 104 to EUD 106. In this way, EUD 106 can display, or otherwise present, the recommendation to an end user. In some embodiments, EUD 106 may be a client device, such as thin client, heavy client, mainframe computer, desktop computer and so on.

Remote server 108 is any computer system that serves at least some data and/or functionality to computer 102. Remote server 108 may be controlled and used by the same entity that operates computer 102. Remote server 108 represents the machine(s) that collect and store helpful and useful data for use by other computers, such as computer 102. For example, in a hypothetical case where computer 102 is designed and programmed to provide a recommendation based on historical data, this historical data may be provided to computer 102 from remote database 138 of remote server 108.

Public cloud 110 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 110 is performed by the computer hardware and/or software of cloud orchestration module 142. The computing resources provided by public cloud 110 are typically implemented by virtual computing environments that run on various computers making up the computers of host physical machine set 144, which is the universe of physical computers in and/or available to public cloud 110. The virtual computing environments (VCEs) typically take the form of virtual machines from virtual machine set 146 and/or containers from container set 148. These VCEs may be stored as images and may be transferred among and between the various physical machine hosts, either as images or after instantiation of the VCE. Cloud orchestration module 142 manages the transfer and storage of images, deploys new instantiations of VCEs, and manages active instantiations of VCE deployments. Gateway 140 is the collection of computer software, hardware, and firmware that allows public cloud 110 to communicate through WAN 104.

Some further explanation of virtualized computing environments (VCEs) will now be provided. VCEs can be stored as “images.” A new active instance of a VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 112 is similar to public cloud 110, except that the computing resources are only available for use by a single enterprise. While private cloud 112 is depicted as being in communication with WAN 104, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this example, public cloud 110 and private cloud 112 are both part of a larger hybrid cloud.

Cloud computing services and/or microservices (not separately shown in FIG. 1): private and public clouds 110 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to an “as a service” technology paradigm where content is being presented to an internal or external customer in the form of a cloud computing service. As-a-service offerings typically provide endpoints with which various customers interface. These endpoints are typically based on a set of application programming interfaces (APIs). One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with such tasks. Another category is Software-as-a-Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

In some implementations, a device (e.g., computer 102, computer system) may receive a sentence to be embedded for search. The device may pair the sentence with itself to create a paired sentence input for a cross-encoder. The device may provide the paired sentence input to the cross-encoder. The device may extract an abstract representation of the sentence from a lower layer of the cross-encoder, where the abstract representation of the sentence is associated with search. The device may index the abstract representation of the sentence in an index for search. The device may search the index for sentences similar to the abstract representation of the sentence.

In some implementations, the device may receive a query input. The device may provide the query input paired with itself to a first cross-encoder. The device may receive a first embedding from a layer of the first cross-encoder that is close to the query input. The device may store the first embedding in a vector index. The device may receive a search request including a target query input. The device may provide the target query input paired with itself to a second cross-encoder. The device may receive a second embedding for the target query input from the layer of the second cross-encoder. The device may search the vector index for a set of embeddings that are closest to the second embedding for the target query input. The device may return a result based on the set of embeddings.

In some implementations, the device may embed a sentence in a cross-encoder by pairing the sentence with itself. The device may extract an abstract representation of the sentence from an earlier layer of the cross-encoder. The device may create an index of sentence embeddings for use in searching for sentences similar to a given query sentence. The device may embed the query sentence using the cross-encoder. The device may search the index for similar sentence embeddings. The device may output the similar sentence embeddings.

In some implementations, a device (e.g., computer 102, computer system) may include means for receiving a sentence to be embedded for search. The device may include means for pairing the sentence with itself to create a paired sentence input for a cross-encoder. The device may include means for providing the paired sentence input to the cross-encoder. The device may include means for extracting an abstract representation of the sentence from a lower layer of the cross-encoder, wherein the abstract representation of the sentence is associated with search. The device may include means for indexing the abstract representation of the sentence in an index for search. The device may include means for searching the index for sentences similar to the abstract representation of the sentence.

In some implementations, the device may include means for providing the query input paired with itself to a first cross-encoder. The device may include means for receiving a first embedding from a layer of the first cross-encoder that is close to the query input. The operations may include storing the first embedding in a vector index. The device may include means for receiving a search request including a target query input. The device may include means for providing the target query input paired with itself to a second cross-encoder. The device may include means for receiving a second embedding for the target query input from the layer of the second cross-encoder. The device may include means for searching the vector index for a set of embeddings that are closest to the second embedding for the target query input. The device may include means for returning a result based on the set of embeddings.

In some implementations, the device may include means for embedding a sentence in a cross-encoder by pairing the sentence with itself. The device may include means for extracting an abstract representation of the sentence from an earlier layer of the cross-encoder. The operations may include creating an index of sentence embeddings for use in searching for sentences similar to a given query sentence. The device may include means for embedding the query sentence using the cross-encoder. The device may include means for searching the index for similar sentence embeddings. The device may include means for outputting the similar sentence embeddings. In some implementations, the means for the device to perform operations described herein may include, for example, one or more of processor set 114, persistent storage 120, and/or cross-encoder search code 150.

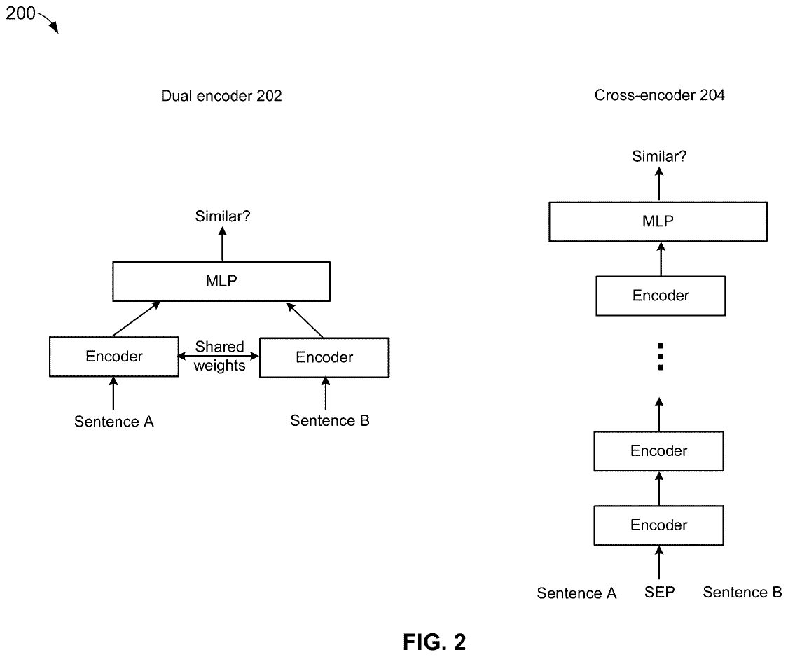

FIG. 2 is a diagram illustrating an example 200 of a dual encoder 202 and a cross-encoder 204. Dual encoders (bi-encoders) may be trained on “Siamese networks” with a loss function to minimize sentence distance in vector space for similar sentences. In the context of dual encoders, a Siamese network is a type of neural network architecture that includes two identical sub-networks, each processing a different input, and then comparing the outputs of these sub-networks. The Siamese network may be used to train two separate encoders (e.g., neural networks) to map input data to a common latent space. The two encoders are trained to produce similar representations for similar inputs, and dissimilar representations for dissimilar inputs. This is achieved by minimizing a distance metric (e.g., cosine similarity, Euclidean distance) between the outputs of the two encoders for similar inputs, and maximizing the distance metric for dissimilar inputs. One encoder of dual encoder 202 in example 200 may be for a query input and the other encoder may be for a candidate input. Each encoder may output to a multi-layer perceptron (MLP). Each encoder may have a set of weights. Dual encoder 202 may have two encoders, for sentence A and for sentence B, that share weights of embedding layers.

A cross-encoder is a type of neural network architecture that consists of multiple layers, which process input data (e.g., text, images) to produce a fixed-size vector representation, also known as an embedding. The layers of a cross-encoder are designed to capture different aspects of the input data. Cross-encoders may be trained on user input that has two sentences and may learn discriminating features to help with similarity decisions.

Cross-encoder 204 has a separator (SEP) between Sentence A and Sentence B. Cross-encoder 204 may have multiple encoder layers. An input layer may receive the query input, which is typically a sequence of tokens (e.g., words, characters) or a pair of sequences (e.g., two sentences). The input layer is responsible for transforming the query input into a numerical representation that can be processed by the subsequent layers. An embedding layer maps the input tokens to a dense vector representation, called an embedding. The embedding layer is typically a lookup table that stores a set of pre-trained embeddings, which are learned during training. The embedding layer outputs a sequence of vectors, where each vector represents a token in the input sequence. Encoder layers are a series of identical or similar layers that process the input sequence. A pooling layer is used to combine the output of the encoder layers into a fixed-size vector representation. The pooling layer can be a simple concatenation of the output vectors, or a more complex operation, such as max pooling or average pooling. The final layer, or output layer, produces the output of the cross-encoder, which is typically a fixed-size vector representation of the input data. The output layer may also include additional components, such as a classification layer or a regression layer, depending on the specific task being performed. In a typical cross-encoder architecture, the encoder layers are stacked on top of each other, with the output of each layer serving as the input to the next layer. The number of encoder layers can vary depending on the specific architecture and the complexity of the task being performed.

Cross-encoders involve heavy processing costs for direct searches, but are more accurate than dual encoders. Cross-encoders are not used for search, because each input query has to take sentence pairs and has to be compared with the entire cross-encoder corpus or training dataset. However, dual encoders are harder to train and tend to be less accurate than cross-encoders. Searches may consumer a lot of time and processing resources.

FIG. 3 is a diagram illustrating an implementation 300 of a cross-encoder using a sentence paired with itself. Cross-encoders may start with weights of a pretrained model and learn how to abstract representations that are useful to classify sentences of the same meaning. According to some implementations, a cross-encoder may use an item (e.g., sentence, table column) that is paired with itself. Cross-encoders require a pair of items. An item may be paired with itself to provide a good representation at lower layers of the cross-encoder. Cross-encoder 302 in implementation 300 may include Sentence A paired with itself (Sentence A and Sentence A).

In a neural network, a hidden state is a vector representation of the input data that is computed by the model at a particular layer or time step. Hidden states are internal representations of the input data that are used by the model to compute the output. In a cross-encoder architecture, the hidden states are the output vectors of the encoder layers, which represent the contextualized representation of the input text. These hidden states capture the semantic meaning of the input text, including the relationships between different tokens, entities, and concepts.

Each layer may have a pool of hidden states 304 for one element of the pair. Pooling the hidden states is a technique used to combine the output vectors of the encoder layers into a fixed-size vector representation. Pooling can reduce the dimensionality of the output vector, making it easier to process and reducing the risk of overfitting. Pooling can also help to capture the most relevant information. Max pooling involves computing the maximum value along a particular axis (e.g., time axis) of the hidden states. A verage pooling involves computing the average value along a particular axis of the hidden states. Sum pooling involves computing the sum of the hidden states along a particular axis. Concatenation involves concatenating the hidden states along a particular axis to form a single vector. By pooling the hidden states of the encoder layers, the computer system can obtain a fixed-size vector representation of the input sentence. By comparing the pooled hidden states of two sentences, the computer system can compute a similarity score between them.

The pool of hidden states 304 may be used as the embedding for the sentence pair, to see if the sentence pair is effective for search. In implementation 300, an embedding may include the sentence pair. Lower layers of the cross-encoder 302 may have good representations for search. That is, hidden states of earlier, lower layers of the cross-encoder 302 may be used for search.

In some implementations, the embedding may be an element of a k-nearest-neighbor (KNN) index. A KNN index is used in information retrieval and similarity search applications that allows for efficient searching and retrieval of the k most similar items (nearest neighbors) to a given query item. A KNN index maps high-dimensional data (e.g., images, text, or audio) to a lower-dimensional space, where similarity can be measured more easily.

In the context of cross-encoders, extracting an abstract sentence representation involves processing the input sentence through the encoder layers and then extracting a vector representation that captures the semantic meaning of the sentence. The input sentence is first tokenized into individual words or subwords, depending on the specific architecture. The tokenized input sentence is then passed through the encoder layers, which include multiple identical or similar layers. Each layer may apply self-attention, followed by a feed-forward network (FFN) to transform the input representations.

The output of each encoder layer is a set of hidden states, which represent the contextualized representation of the input sentence. These hidden states capture the semantic meaning of the sentence, including the relationships between different tokens, entities, and concepts. To extract an abstract sentence representation, the computer system may combine the hidden states in a way that captures the essential information. This is typically done by pooling the hidden states, as described above. The pooled vector representation is the abstract sentence representation, which captures the semantic meaning of the input sentence. The abstract sentence representation may be a vector that captures the essential information in the input sentence, including the semantic meaning of the sentence (including the relationships between entities, concepts, and ideas), contextual information (e.g., surrounding words, entities, and concepts), and syntactic structure (phrase structure and the relationships between clauses). The representation is called “abstract” because the abstract representation is not a direct representation of the input sentence, but rather a higher-level representation that captures the underlying meaning and context. This abstraction process allows the computer system to generalize across sentences such that the abstract representation can be used to compare and contrast different sentences, even if they have different wording or structure. The abstraction also captures a nuanced meaning, including subtle differences in meaning between sentences, including idiomatic expressions, figurative language, and implied meaning.

For example, a computer system (e.g., computer 102) may embed a sentence (Sentence A) with itself in one or more layers of the cross-encoder 302. The computer system may use a hidden cross-encoder state as the embedding. The computer system may extract an abstract representation of the sentence directly from the cross-encoder 302. To extract layer-wise embeddings, the computer system may pool the hidden tokens of the sentence for each layer, excluding padding and separator tokens. Token embeddings, also known as token representations, are vectors that represent individual tokens in a sequence. These vectors are learned during training and are used as input to the transformer model. Each token in the sequence is embedded into a vector space, where semantically similar tokens are located close to each other.

In some implementations, the computer system may infuse one or more bi-encoders with cross-encoder information. The computer system may use a cross-encoder state as the first layers of a bi-encoder. The layers may be trained as normal. In some implementations, the computer system may initialize the bi-encoder's weights with the pre-trained weights of a cross-encoder. That is, the computer system may initialize the bi-encoder with cross-encoder weights and re-train the bi-encoder using a simpler training regimen. This allows the bi-encoder to inherit some of the knowledge learned by the cross-encoder. The computer system may concatenate or average the embedding from early layers of the bi-encoder with the embeddings from early layers of the cross-encoder. The computer system may train the bi-encoder and cross-encoder jointly, using a multi-task learning approach. The computer system may fuse the bi-encoder and cross-encoder at specific layers, allowing the bi-encoder to access the cross-encoder's representations at different levels of abstraction. By infusing a bi-encoder with cross-encoder information, the computer system can leverage the strengths of both architectures and potentially improve the performance of the bi-encoder on similarity search tasks. As a result, the training process may be shortened with smaller models to speed up the inference process.

In some implementations, the computer system may retrain the cross-encoder with the same dataset, using the same loss for training a bi-encoder. The computer system may reduce the training to two layers or train the full 12-layer network. The computer system may simplify the training dataset to exclude “hard negatives” from other cross-encoders.

FIG. 4 is a diagram of an example implementation 400 for using a cross-encoder for search. As shown in FIG. 4, a computer system (e.g., computer 102) may perform a search using a trained cross-encoder 402 that has multiple encoder layers, such as layer 404, layer 406, and so forth. Each layer may have token embeddings 408.

At 405, the computer system may receive a query input, such as a sentence, that is to be embedded. The query input may be part of a search input or prompt. At 410, the computer system may pair the sentence with itself and provide the sentence pair to the cross-encoder 402.

At 415, the computer system may extract an abstract representation of the sentence from a lower layer, such as layer 404. Layer 404 may be an embedding layer or a first layer. At 420, the computer system may index the abstract representation in an index. Indexing is the process of organizing and storing data in a way that enables fast and efficient retrieval of relevant information. In the context of similarity search, indexing involves creating a data structure that allows for quick lookup and comparison of abstract representations.

At 425, the computer system may search the index for similar sentences. Searching the index involves querying the indexed data structure to find the most similar sentences to a given input sentence. The computer system may retrieve a set of sentences that are semantically close to the query sentence. The computer system may identify similar sentences in search results.

At 430, the computer system may refine the search. Refining the search may involve filtering, ranking, or re-ranking the search results to improve their relevance, accuracy, or usefulness. This may reduce information overload and increase the chances of finding the desired information.

FIGS. 5A and 5B are diagrams of an example implementation 500 associated with using a cross-encoder for search. As shown in FIG. 5A, the computer system may perform a search using a trained cross-encoder 502 that has multiple encoder layers, such as layer 504, layer 506, and so forth. Each layer may have token embeddings 508.

At 505 of FIG. 5A, the computer system may receive a query input for search. The query input may be a sentence, a table column, a paragraph, or another type of input. At 510, the computer system may provide the query input, paired with itself, to the cross-encoder 502. The layers of the cross-encoder 502 may convert each token in the input sequence into an embedded vector representation. The embedded vector representation is then passed through one or more layers of the cross-encoder 502, to generate a contextualized or abstract representation of the input sequence. The abstract representation is a set of vectors that capture the semantic relationships between the tokens in the input sequence. The output of the encoder is a set of vectors that can be used as input to a downstream task, such as machine translation or text classification.

At 515, the computer system may receive a first embedding from a layer closer to the query input. At 520, the computer system may store the first embedding in a vector index 512.

The vector index 512 may be used for a later search.

As part of the later search, at 525 of FIG. 5B, the computer system may receive a target query input in a search request from a user. At 530, the computer system may provide the target query, paired with itself, to a cross-encoder 524, which may be the same cross-encoder or a second cross-encoder. The lower layer 532 may include pooled token embeddings 534 that are used to generate an abstract representation of the target query input.

At 535, the computer system may receive a second embedding from layer 532. At 540, the computer system may search the vector index 512 for a set of embeddings closest to the second embedding. At 545, the computer system may return a result based on the set of embeddings. The result may be a similar item (e.g., sentence, table column) as that of the target query input.

FIG. 6 is a flowchart of an example process 600 associated with using a cross-encoder for search. One or more process blocks of FIG. 6 are performed by a computer system (e.g., computer 102) and/or by another device or a group of devices separate from or including the computer system.

As shown in FIG. 6, process 600 includes receiving a sentence to be embedded for search (block 610). For example, the computer system may receive a sentence to be embedded for search, as described above.

As further shown in FIG. 6, process 600 includes pairing the sentence with itself to create a paired sentence input for a cross-encoder (block 620). For example, the computer system may pair the sentence with itself to create a paired sentence input for a cross-encoder, as described above.

As further shown in FIG. 6, process 600 includes providing the paired sentence input to the cross-encoder (block 630). For example, the computer system may provide the paired sentence input to the cross-encoder, as described above.

As further shown in FIG. 6, process 600 includes extracting an abstract representation of the sentence from a lower layer of the cross-encoder, where the abstract representation of the sentence is associated with search (block 640). For example, the computer system may extract an abstract representation of the sentence from a lower layer of the cross-encoder, where the abstract representation of the sentence is associated with search, as described above.

As further shown in FIG. 6, process 600 includes indexing the abstract representation of the sentence in an index for search (block 650). For example, the computer system may index the abstract representation of the sentence in an index for search, as described above.

As further shown in FIG. 6, process 600 includes searching the index for sentences similar to the abstract representation of the sentence (block 660). For example, the computer system may search the index for sentences similar to the abstract representation of the sentence, as described above.

Process 600 may include additional aspects, such as any single aspect or any combination of aspects described below and/or in connection with one or more other processes described elsewhere herein.

In a first aspect, the lower layer of the cross-encoder comprises one or more of an embedding layer, a zeroth layer, or a first layer of the cross-encoder.

In a second aspect, alone or in combination with the first aspect, the abstract representation of the sentence is extracted from the lower layer of the cross-encoder by pooling hidden states from the lower layer.

In a third aspect, alone or in combination with one or more of the first and second aspects, the cross-encoder is a pre-trained cross-encoder trained on sentence pairs to detect relatedness between sentences.

In a fourth aspect, alone or in combination with one or more of the first through third aspects, the indexing of the abstract representation comprises storing the abstract representation in a KNN index for search.

In a fifth aspect, alone or in combination with one or more of the first through fourth aspects, the searching of the index comprises searching the index using a query sentence to find similar sentences to the query sentence.

In a sixth aspect, alone or in combination with one or more of the first through fifth aspects, the sentence comprises a column of a table.

In a seventh aspect, alone or in combination with one or more of the first through sixth aspects, the cross-encoder is a cross-encoder for tables trained to detect relatedness between columns of tables.

In an eighth aspect, alone or in combination with one or more of the first through seventh aspects, process 600 includes training a dual encoder using the abstract representation of the sentence from the cross-encoder.

In a ninth aspect, alone or in combination with one or more of the first through eighth aspects, the dual encoder is trained using a simpler training regimen than training a dual encoder from an initial state. The simpler training regimen may have fewer parameters than normally expected for training a dual encoder. The number of parameters of the simpler training regimen may be below a parameter number threshold. The simpler training regimen may have fewer layers, such as below a layer threshold. The dataset for the simpler training regimen may exclude hard negatives from other cross-encoders.

In a tenth aspect, alone or in combination with one or more of the first through ninth aspects, process 600 includes refining results of the search by reranking the results with the cross-encoder.

Although FIG. 6 shows example blocks of process 600, in some implementations, process 600 includes additional blocks, fewer blocks, different blocks, or differently arranged blocks than those depicted in FIG. 6. Additionally, or alternatively, two or more of the blocks of process 600 may be performed in parallel.

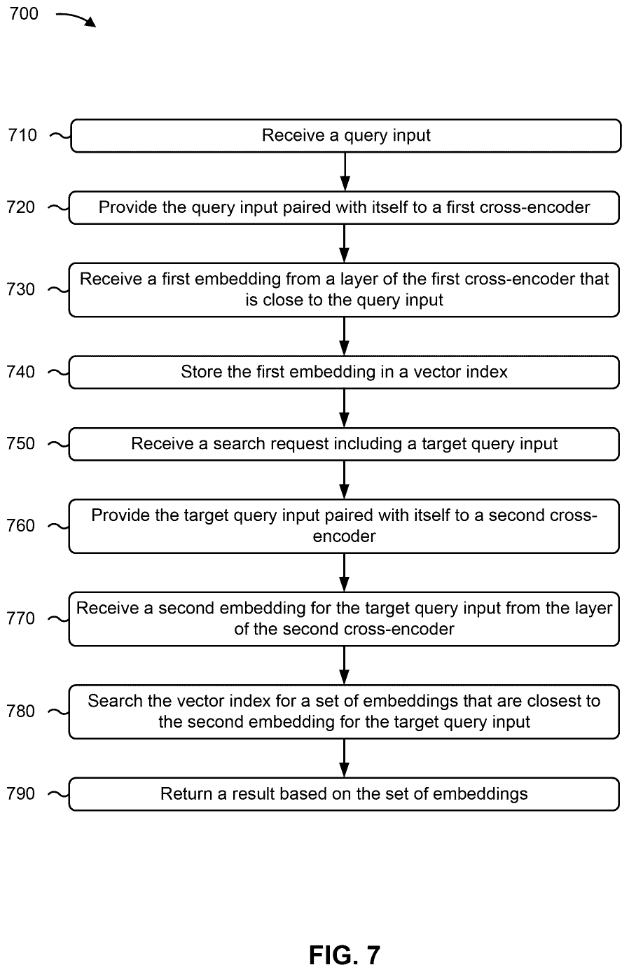

FIG. 7 is a flowchart of an example process 700 associated with using a cross-encoder for search. One or more process blocks of FIG. 7 are performed by a computer system (e.g., computer 102) and/or by another device or a group of devices separate from or including the computer system.

As shown in FIG. 7, process 700 includes receiving a query input (block 710). For example, the computer system may receive a query input, as described above.

As further shown in FIG. 7, process 700 includes providing the query input paired with itself to a first cross-encoder (block 720). For example, the computer system may provide the query input paired with itself to a first cross-encoder, as described above.

As further shown in FIG. 7, process 700 includes receiving a first embedding from a layer of the first cross-encoder that is close to the query input (block 730). For example, the computer system may receive a first embedding from a layer of the first cross-encoder that is close to the query input, as described above.

As further shown in FIG. 7, process 700 includes storing the first embedding in a vector index (block 740). For example, the computer system may store the first embedding in a vector index, as described above.

As further shown in FIG. 7, process 700 includes receiving a search request including a target query input (block 750). For example, the computer system may receive a search request including a target query input, as described above.

As further shown in FIG. 7, process 700 includes providing the target query input paired with itself to a second cross-encoder (block 760). For example, the computer system may provide the target query input paired with itself to a second cross-encoder, as described above.

As further shown in FIG. 7, process 700 includes receiving a second embedding for the target query input from the layer of the second cross-encoder (block 770). For example, the computer system may receive a second embedding for the target query input from the layer of the second cross-encoder, as described above.

As further shown in FIG. 7, process 700 includes searching the vector index for a set of embeddings that are closest to the second embedding for the target query input (block 780). For example, the computer system may search the vector index for a set of embeddings that are closest to the second embedding for the target query input, as described above.

As further shown in FIG. 7, process 700 includes returning a result based on the set of embeddings (block 790). For example, the computer system may return a result based on the set of embeddings, as described above.

Process 700 may include additional aspects, such as any single aspect or any combination of aspects described below and/or in connection with one or more other processes described elsewhere herein.

In a first aspect, the first cross-encoder and the second cross-encoder are the same cross-encoder.

In a second aspect, alone or in combination with the first aspect, the layer of the first cross-encoder close to the query input is one of a first layer or a second layer of the first cross-encoder.

In a third aspect, alone or in combination with one or more of the first and second aspects, the operations comprise pretraining the second cross-encoder on a paired-input training dataset before performing the providing and returning operations.

In a fourth aspect, alone or in combination with one or more of the first through third aspects, the query input comprises one of a table column or a sentence, and the result comprises an indication of one of a related table column or a related sentence based on the set of embeddings.

Although FIG. 7 shows example blocks of process 700, in some implementations, process 700 includes additional blocks, fewer blocks, different blocks, or differently arranged blocks than those depicted in FIG. 7. Additionally, or alternatively, two or more of the blocks of process 700 may be performed in parallel.

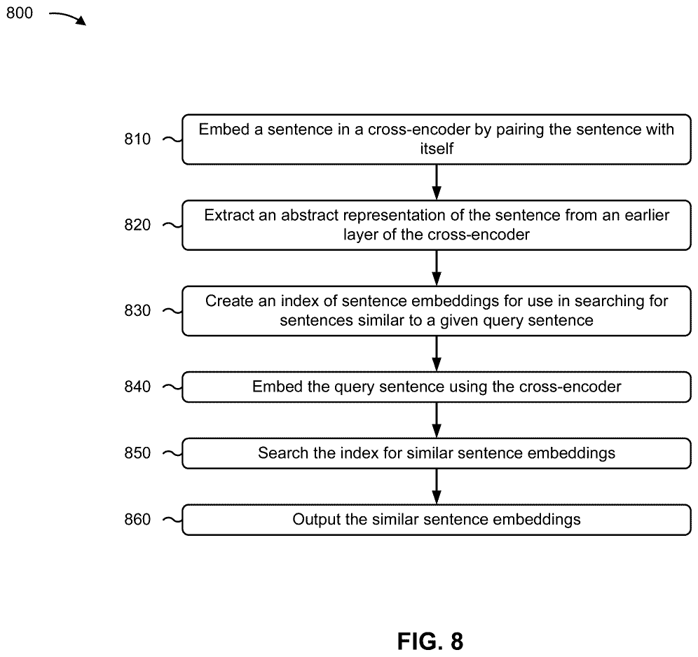

FIG. 8 is a flowchart of an example process 800 associated with using a cross-encoder for search. One or more process blocks of FIG. 8 are performed by a computer system (e.g., computer 102) and/or by another device or a group of devices separate from or including the computer system.

As shown in FIG. 8, process 800 includes embedding a sentence in a cross-encoder by pairing the sentence with itself (block 810). For example, the computer system may embed a sentence in a cross-encoder by pairing the sentence with itself, as described above.

As further shown in FIG. 8, process 800 includes extracting an abstract representation of the sentence from an earlier layer of the cross-encoder (block 820). For example, the computer system may extract an abstract representation of the sentence from an earlier layer of the cross-encoder, as described above.

As further shown in FIG. 8, process 800 includes creating an index of sentence embeddings for use in searching for sentences similar to a given query sentence (block 830). For example, the computer system may create an index of sentence embeddings for use in searching for sentences similar to a given query sentence, as described above.

As further shown in FIG. 8, process 800 includes embedding the query sentence using the cross-encoder (block 840). For example, the computer system may embed the query sentence using the cross-encoder, as described above.

As further shown in FIG. 8, process 800 includes searching the index for similar sentence embeddings (block 850). For example, the computer system may search the index for similar sentence embeddings, as described above.

As further shown in FIG. 8, process 800 includes outputting the similar sentence embeddings (block 860). For example, the computer system may output the similar sentence embeddings, as described above.

Process 800 may include additional aspects, such as any single aspect or any combination of aspects described below and/or in connection with one or more other processes described elsewhere herein.

In a first aspect, the operations further comprise embedding columns of a table using the cross-encoder, and extracting an abstract representation of the columns from an earlier layer of the cross-encoder, creating an index of column embeddings for use in searching for columns similar to a given query column, embedding the query column using the cross-encoder, and searching the index for similar column embeddings.

In a second aspect, alone or in combination with the first aspect, the extracting of the abstract representation comprises extracting the abstract representation by pooling hidden states from the earlier layer or a lower layer of the cross-encoder.

In a third aspect, alone or in combination with one or more of the first and second aspects, the hidden states are pooled using a sum pooling operation or a maximum pooling operation.

Although FIG. 8 shows example blocks of process 800, in some implementations, process 800 includes additional blocks, fewer blocks, different blocks, or differently arranged blocks than those depicted in FIG. 8. Additionally, or alternatively, two or more of the blocks of process 800 may be performed in parallel.

The foregoing disclosure provides illustration and description, but is not intended to be exhaustive or to limit the implementations to the precise forms disclosed. Modifications may be made in light of the above disclosure or may be acquired from practice of the implementations. For example, various aspects of this disclosure are described by narrative text, flowcharts, block diagrams of computer systems and/or block diagrams of the machine logic included in computer program product (CPP) embodiments. With respect to any flowcharts, depending upon the technology involved, the device can be performed in a different order than what is shown in a given flowchart. For example, again depending upon the technology involved, two device shown in successive flowchart blocks may be performed in reverse order, as a single integrated step, concurrently, or in a manner at least partially overlapping in time.

The descriptions of the various embodiments of the present invention have been presented for purposes of illustration, but are not intended to be exhaustive or limited to the embodiments disclosed. M any modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

A computer program product embodiment (“CPP embodiment” or “CPP”) is a term used in this disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, RAM, ROM, erasable programmable read-only memory (EPROM or Flash memory), static random access memory (SRAM) , compact disc read-only memory (CD-ROM) , digital versatile disk (DVD), memory stick, floppy disk, mechanically encoded device (such as punch cards or pits/lands formed in a major surface of a disc), or any suitable combination of the foregoing. A computer-readable storage medium, as that term is used in this disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X ; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1. A method comprising:
receiving a text sentence to be embedded for search;
pairing the text sentence with itself to create a paired sentence input for a cross-encoder, wherein the pairing of the text sentence with itself comprises pairing the text sentence with the text sentence;
providing the paired sentence input to the cross-encoder;
extracting an abstract representation of the text sentence from a lower layer of the cross-encoder, wherein the abstract representation of the text sentence is associated with search;
indexing the abstract representation of the text sentence in an index, wherein the indexing comprises creating a data structure, wherein the data structure allows efficient lookup and comparison of abstract representations; and
searching the index for sentences similar to the abstract representation of the text sentence.

2. The method of claim 1, wherein the lower layer of the cross-encoder comprises one or more of an embedding layer, a zeroth layer, or a first layer of the cross-encoder.

3. The method of claim 1, wherein the abstract representation of the text sentence is extracted from the lower layer of the cross-encoder by pooling hidden states from the lower layer.

4. The method of claim 1, wherein the cross-encoder is a pre-trained cross-encoder trained on sentence pairs to detect relatedness between sentences.

5. The method of claim 1, wherein the indexing of the abstract representation comprises storing the abstract representation in a k-nearest-neighbor index for search.

6. The method of claim 1, wherein the searching of the index comprises searching the index using a query sentence to find similar sentences to the query sentence.

7. The method of claim 1, wherein the text sentence comprises a column of a table.

8. The method of claim 1, wherein the cross-encoder is a cross-encoder for tables trained to detect relatedness between columns of tables.

9. The method of claim 1, further comprising training a dual encoder using the abstract representation of the text sentence from the cross-encoder.

10. The method of claim 9, further comprising training the dual encoder using a simpler training regimen than training from an initial state, and wherein the simpler training regimen includes a number of parameters that is below a parameter number threshold or a number of layers below a layer threshold.

11. The method of claim 1, further comprising refining results of the search by reranking the results with the cross-encoder.

12. A computer system comprising:
a processor set;
one or more computer-readable storage media;
program instructions stored on the one or more computer-readable storage media to cause the processor set to perform operations comprising:
receiving a query input text;
providing the query input text paired with itself to a first cross-encoder, wherein providing the query input text paired with itself to the first cross-encoder comprises pairing the query input text with the query input text;
receiving a first embedding from a lower layer of the first cross-encoder;
storing the first embedding in a vector index;
receiving a search request including a target query input;
providing the target query input paired with itself to a second cross-encoder;
receiving a second embedding for the target query input from a layer of the second cross-encoder;
searching the vector index for a set of embeddings; and
returning a result based on the set of embeddings.

13. The computer system of claim 12, wherein the first cross-encoder and the second cross-encoder are the same cross-encoder.

14. The computer system of claim 12, wherein the lower layer of the first cross-encoder is one of a first layer or a second layer of the first cross-encoder.

15. The computer system of claim 12, wherein the operations comprise:
pretraining the second cross-encoder on a paired-input training dataset before performing the providing and returning operations.

16. The computer system of claim 12, wherein the query input text comprises one of a table column or a text sentence, and the result comprises an indication of one of a related table column or a related text sentence based on the set of embeddings.

17. A computer program product comprising:
one or more computer-readable storage media;
program instructions stored on the one or more computer-readable storage media to perform operations comprising:
embedding a text sentence in a cross-encoder by pairing the text sentence with itself, wherein the pairing of the text sentence with itself comprises pairing the text sentence with the text sentence;
extracting an abstract representation of the text sentence from a lower layer of the cross-encoder;
creating an index of sentence embeddings for use in searching for sentences similar to a query sentence;
embedding the query sentence using the cross-encoder;
searching the index for similar sentence embeddings; and
outputting the similar sentence embeddings.

18. The computer program product of claim 17, wherein the operations further comprise:
embedding columns of a table using the cross-encoder;
extracting an abstract representation of the columns from the cross-encoder;
creating an index of column embeddings for use in searching for columns similar to a query column;
embedding the query column using the cross-encoder; and
searching the index of column embeddings for similar column embeddings.

19. The computer program product of claim 17, wherein the extracting of the abstract representation comprises extracting the abstract representation by pooling hidden states from the lower layer of the cross-encoder.

20. The computer program product of claim 19, wherein the hidden states are pooled using a sum pooling operation or a maximum pooling operation.
